(19) United States
(12) Patent Application Publication
(10) Pub. No.: US 2011/0032207 A1
(43) Pub. Date: Feb. 10, 2011

(54) CAPACITIVE TOUCH SENSOR

(75) Inventors: Kuan Ming Huang, Tainan County (TW); Chung Che Tsou, Taoyuan County (TW); Xian Bin Lee, Taoyuan County (TW); Wen Tsai Lee, Hsinchu County (TW); Wen Shiuan Huang, Taichung County (TW)

Correspondence Address: WPAT, PC;INTELLECTUAL PROPERTY ATTORNEYS, 2030 MAIN STREET, SUITE 1300, IRVINE, CA, 92614, US

(73) Assignee: RITDISPLAY CORPORATION, Hsinchu (TW)

(21) Appl. No.: 12/571,944

(22) Filed: Oct. 1, 2009

(30) Foreign Application Priority Data
Aug. 7, 2009 (CN) 200910162823.3

(51) Int. Cl. G06F 3/045

(52) U.S. Cl. 345/174

(57) ABSTRACT

A capacitive touch panel comprises a transparent substrate, a light shielding layer and a capacitive sensing circuit device. The capacitive sensing circuit device is disposed above a surface of the transparent substrate, and comprises a sensing region and a plurality of metal leads. The sensing region comprises a plurality of metallic bridging wires. The plurality of metal leads is disposed on the sides of the sensing region, and is electrically connected to the sensing region. The area of the light shielding layer overlaps the plurality of conductive bridging wires.

### BACKGROUND OF THE INVENTION

1. Field of the Invention

The present invention relates to a light-transmittable touch panel, and more particularly, to a touch panel having capacitance circuits.

2. Description of the Related Art

Touch panels have been widely applied in the fields of household appliances, communications, and electronic information devices. Common applications of the touch panel include input interfaces of personal digital assistants (PDA), electrical appliances, game machines, etc. The current trend of integration of touch panel and display panel allows a user to use his or her finger or a stylus to indicate a control icon shown on the panel in order to execute a desired function on a PDA, electrical appliance, game machine, etc. The touch panel is also applied in public information inquiry systems to provide an efficient operation system for the public.

A conventional touch panel comprises a transparent substrate having a surface on which sensing zones are distributed for sensing a signal associated with the touch of a user's finger or stylus to effect input and control. The sensing zones are made of transparent conductive membranes, such as indium tin oxide (ITO), and a user may touch the transparent conductive membrane corresponding to a specific location shown on the display to effect operation of the device.

In order to detect the location at which a finger or a stylus touches the touch panel, a variety of capacitive touch panel techniques have been developed. As shown in FIG. 1A, a light-transmittable touch panel 10 comprises a transparent substrate 11, a plurality of bridging wires 12, an insulation layer 13 and a transparent conductive layer 14. The transparent conductive layer 14 is patterned and formed on the transparent substrate 11 by a photolithography process, and includes a plurality of first cells 141, a plurality of second cells 142 and a plurality of connecting wires 143. The plurality of first cells 141 and the plurality of second cells 142 are arranged in a staggered manner. Each of the plurality of first cells 141 is surrounded by four of the second cells 142. Each of the connecting wires 143 respectively connects two neighboring second cells 142. The insulation layer 13 further comprises a plurality of insulating areas 131 respectively covering the plurality of connecting wires 143. The plurality of bridging wires 12 are respectively disposed on the plurality of insulating areas 131 and respectively connect two adjacent of the first cells 141. A plurality of metal wires 15 are disposed around the transparent conductive layer 14. The plurality of metal wires 15 can transmit sensing signals to the outside from the plurality of first cells 141 transversely connected and the plurality of second cells 142 longitudinally connected.

The plurality of bridging wires 12 and the plurality of metal wires 15 are all made of metal capable of reflecting light. When the light-transmittable touch panel 10 is used to select or operate the functions shown on a display thereunder, the plurality of bridging wires 12 and the plurality of metal wires 15 reflect the light so that bright lines or bright strips occur. Therefore, viewers may be observe defective images.

In addition, some prior arts add a lens to the light-transmittable touch panel 10 and place a black matrix between the lens and the light-transmittable touch panel 10. The black matrix shields the edges of the panel where the metal wires exist. Therefore, the bright lines or the bright strips cannot occur due to the covering of the black matrix. However, the lens and the substrate 11 of the light-transmittable touch panel 10 are all made of glass. In this regard, the material cost is increased and the manufacturing steps are complicated, and the lens absorbs light so as to darken the monitor.

Thus, there is a need for a touch panel that resolves the above issues with the conventional touch panels and reduces the manufacturing cost.

### SUMMARY OF THE INVENTION

An aspect of the present invention is to provide a light-transmittable touch panel. The bridging wires and the light shielding layer of the touch panel overlap each other, and so bright spots or lines do not occur in the sensing area of the touch panel.

The present invention discloses a capacitive touch panel comprising a transparent substrate, a light shielding layer and a capacitive sensing circuit device. The capacitive sensing circuit device is disposed above a surface of the transparent substrate, and comprises a sensing region and a plurality of metal leads. The sensing region comprises a plurality of metallic bridging wires. The plurality of metal leads is disposed on the sides of the sensing region, and is electrically connected to the sensing region. The light shielding layer overlaps the area of the plurality of conductive bridging wires.

In an embodiment, the light shielding layer of the present invention is directly disposed on a surface of the substrate, and the capacitive sensing circuit device is directly disposed on the light shielding layer.

In another embodiment, the light shielding layer of the present invention is directly disposed on a surface of the substrate, and the capacitive sensing circuit is directly disposed on a surface of the substrate.

### BRIEF DESCRIPTION OF THE DRAWINGS

The invention will be described according to the appended drawings in which:

FIG. 1A is a schematic diagram of a conventional touch panel;

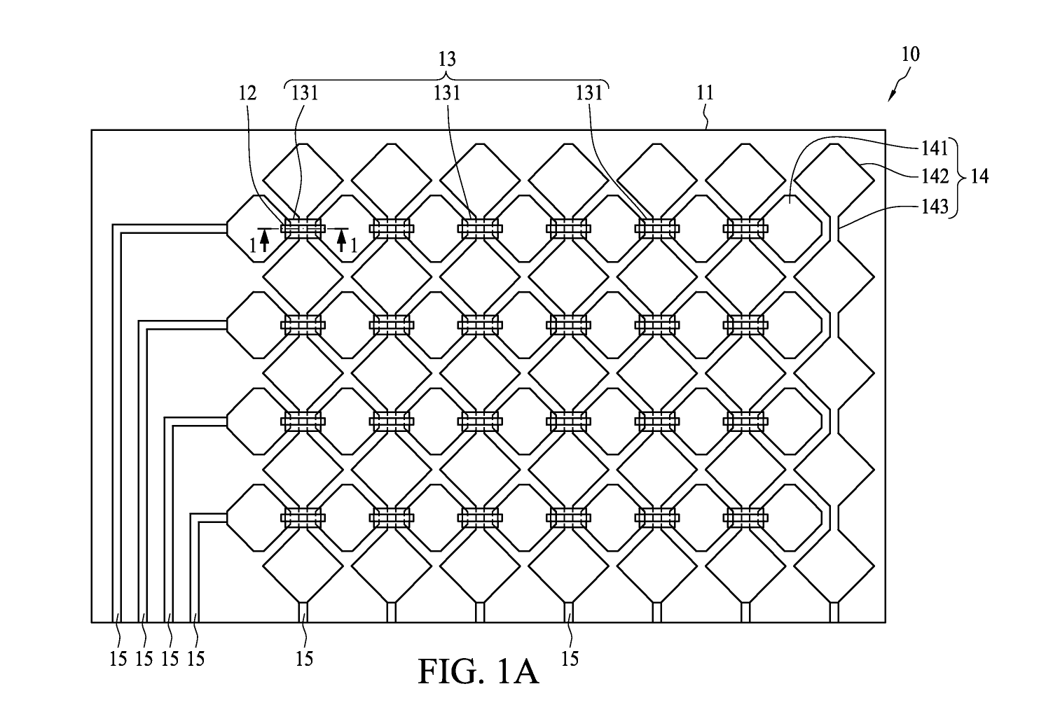

FIG. 1B is a cross-sectional view along line 1-1 in FIG. 1A;

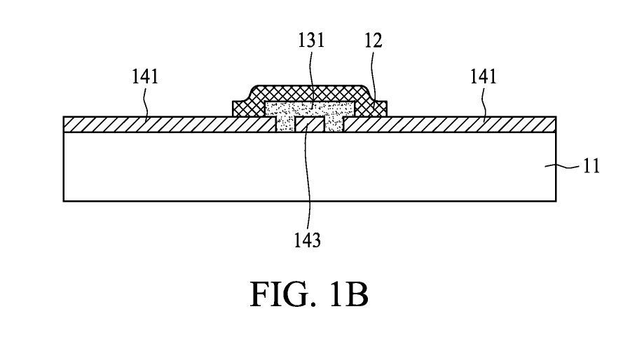

FIG. 2A is a cross-sectional diagram of a touch panel in accordance with an embodiment of the present invention;

FIG. 2B is a schematic diagram of a touch panel in accordance with an embodiment of the present invention;

FIG. 3 is a schematic diagram of a touch panel in accordance with an embodiment of the present invention;

FIG. 4 is a schematic diagram of a touch panel in accordance with an embodiment of the present invention;

FIG. 5A is a schematic diagram of a touch panel in accordance with an embodiment of the present invention; and

FIG. 5B is a schematic diagram of a touch panel in accordance with an embodiment of the present invention.

### PREFERRED EMBODIMENT OF THE PRESENT INVENTION

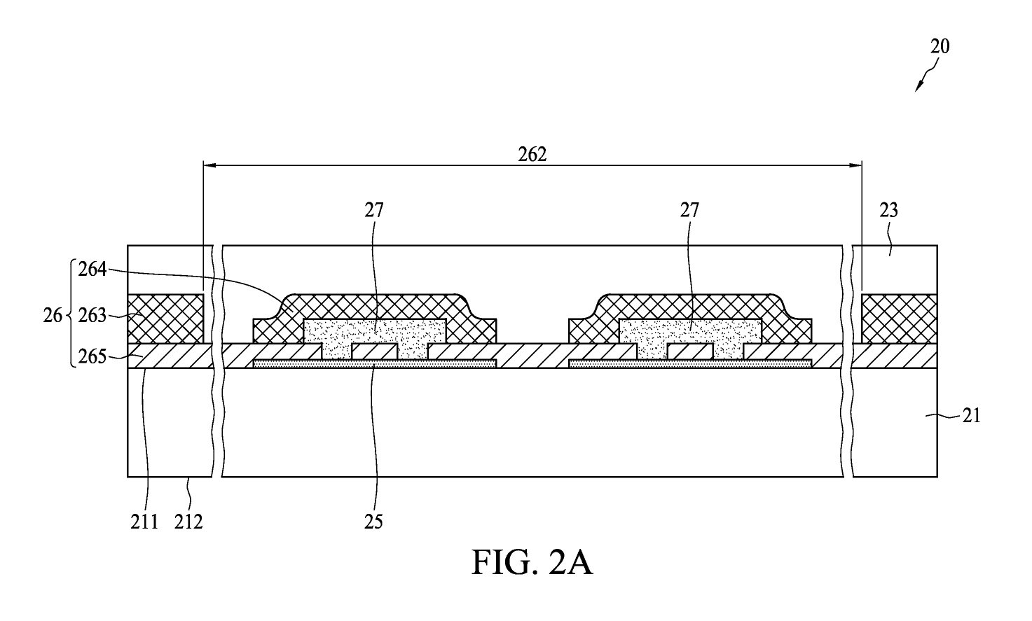

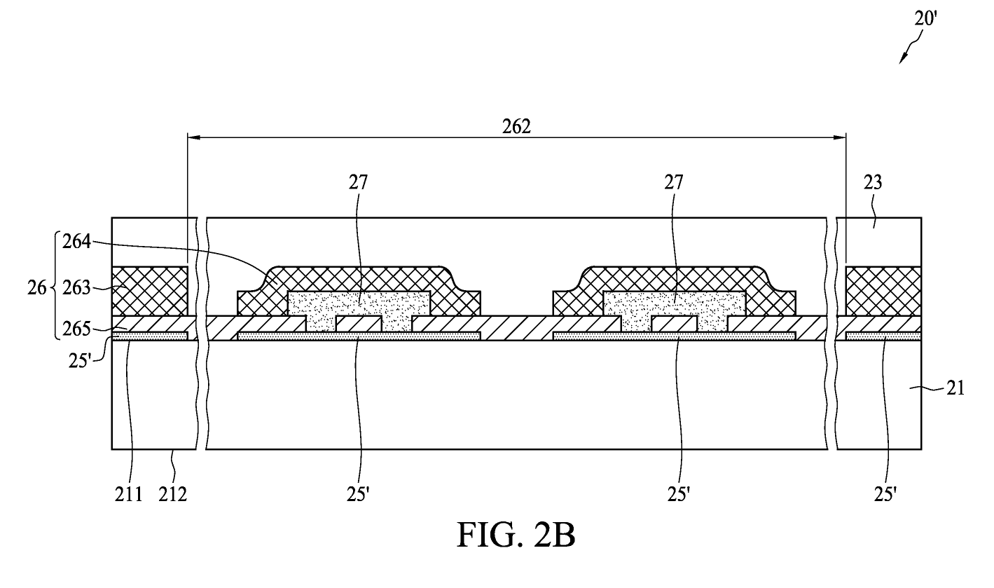

FIG. 2A is a cross-sectional diagram of a touch panel in accordance with an embodiment of the present invention. Referring to FIG. 2A, a capacitive touch panel 20 comprises a transparent substrate 21, a protection layer 23, a light shielding layer 25, a capacitive sensing circuit device 26 and an insulating layer 27. The capacitive sensing circuit device 26 is disposed on the first surface 211 of the transparent substrate 21, and comprises a sensing region 262 and a plurality of metal leads 263. The sensing region 262 comprises a plurality of metallic bridging wires 264 and a transparent conductive layer 265. The plurality of metal leads 263 are disposed around the sensing region 262, and are electrically connected to the sensing region 262. The light shielding layer 25 is directly disposed on a first surface 211 of the substrate 21. That is, the light shielding layer 25 is sandwiched between the capacitive sensing circuit device 26 and the substrate 21. The light shielding layer 25 overlaps the area of the conductive bridging wires 264. When a user uses the capacitive touch panel 20 and views it through the second surface 212 of the substrate 21, the light shielding layer 25 shields the conductive bridging wires 264 so that the issue of reflecting light from the light shielding layer 25 is resolved or reduced. That is, there are no bright dots or bright lines occurring in the sensing area 262. The insulating layer 27 is disposed between the conductive bridging wires 264 and the transparent conductive layer 265 to isolate the conductive bridging wires 264 from a part of the traces of the transparent conductive layer 265.

The material of the transparent substrate 21 is glass or a transparent polymer plate such as polycarbonate (PC) or polyvinyl chloride (PVC). The materials of the transparent conductive layer 265 are ITO, AZO, or IZO. The materials of the conductive bridging wires 264 and the metal leads 263 are silver (Ag), silver alloy, Cr, a composite metal layer of Mo/Al/Mo, or alloy of any of the aforesaid materials. The material of the light shielding layer 25 is chromium oxide (CrOₓ), opaque polymer material or translucent polymer material. The material of the protection layer 23 is a transparent polymer such as photo-resistant material.

is FIG. 2B is a schematic diagram of a touch panel in accordance with an embodiment of the present invention. As shown in FIG. 2B, a capacitive touch panel 20′ comprises a transparent substrate 21, a protection layer 23, a light shielding layer 25′, a capacitive sensing circuit device 26 and an insulating layer 27. The capacitive sensing circuit device 26 is disposed on the first surface 211 of the transparent substrate 21, and comprises a sensing region 262 and a plurality of metal leads 263. The sensing region 262 comprises a plurality of metallic bridging wires 264 and a transparent conductive layer 265. The plurality of metal leads 263 are disposed around the sensing region 262, and are electrically connected to the sensing region 262. The light shielding layer 25′ is directly disposed on a first surface 211 of the substrate 21. That is, the light shielding layer 25′ is sandwiched between the capacitive sensing circuit device 26 and the substrate 21. The light shielding layer 25 overlaps the conductive bridging wires 264 and the metal leads 263. When a user uses the capacitive touch panel 20′ and views it through the second surface 212 of the substrate 21, the light shielding layer 25′ shields the conductive bridging wires 264 and the plurality of metal leads 263 so that the issue of reflecting light from the light shielding layer 25′ is resolved or reduced. That is, there are no bright dots or bright lines occurring in the sensing area 262. Compared with FIGS. 2A and 2B, the light shielding layer 25′ has additional areas covering the plurality of metal leads 263 around the capacitive touch panel 20′.

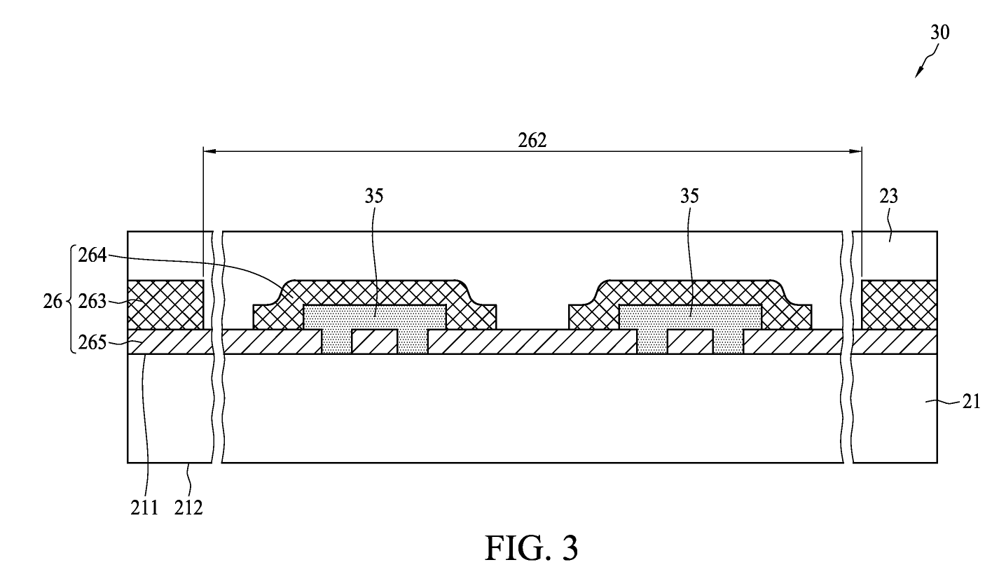

FIG. 3 is a schematic diagram of a touch panel in accordance with an embodiment of the present invention. Compared with FIG. 2A, the light shielding layer 35 of the capacitive touch panel 30 is located in the areas of the capacitive sensing circuit device 26. That is, the light shielding layer 35 is sandwiched between the plurality of conductive bridging wires 264 and the transparent conductive layer 265. Such a structure can also prevent the reflection of light by the plurality of conductive bridging wires 264.

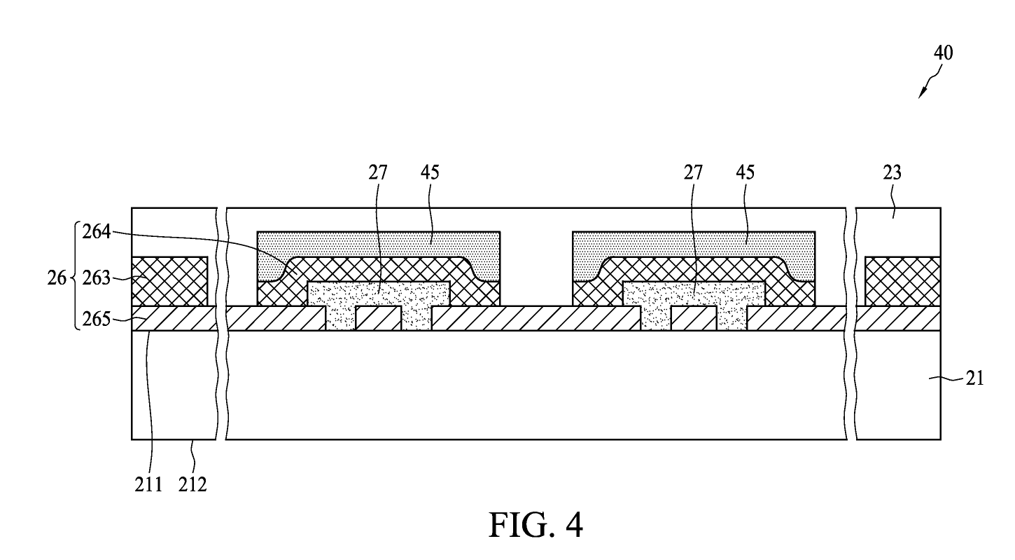

FIG. 4 is a schematic diagram of a touch panel in accordance with an embodiment of the present invention. The light shielding layer 45 of the capacitive touch panel 40 is disposed on the plurality of conductive bridging wires 264. That is, the light shielding layer 45 is disposed between the protection layer 23 and the plurality of conductive bridging wires 264. A user can view and use the capacitive touch panel 40 from the side on which the protection layer 23 is located.

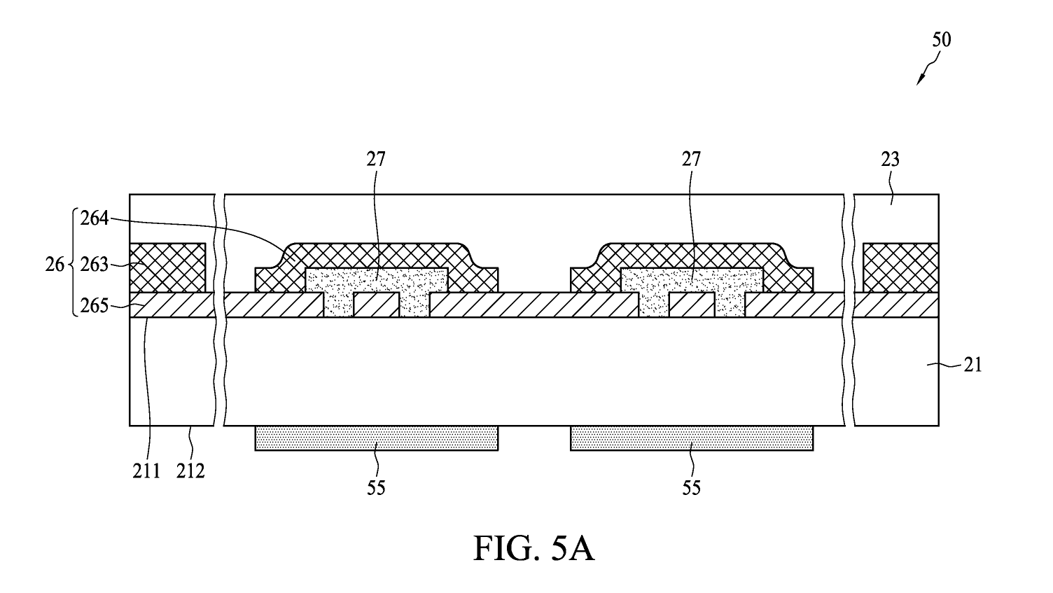

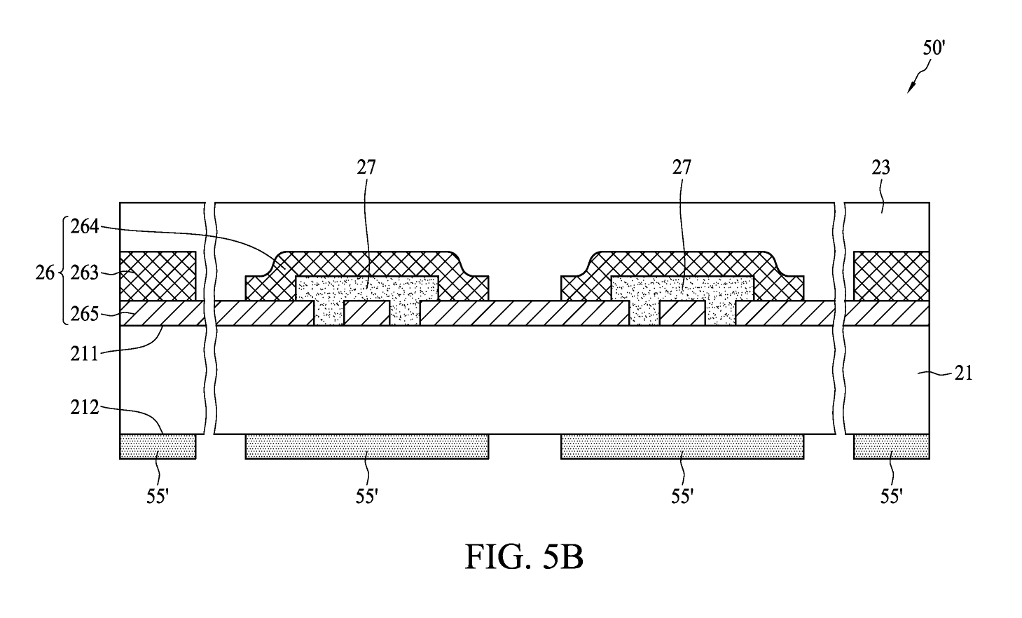

FIG. 5A is a schematic diagram of a touch panel in accordance with an embodiment of the present invention. Compared with the aforesaid several embodiments, the light shielding layer 55 of the capacitive touch panel 50 is disposed on the second surface 212 of the transparent substrate 21 opposite the surface of the transparent substrate 21 on which the capacitive sensing circuit device 26 is disposed. Such a structure can also prevent the reflection of light by the plurality of conductive bridging wires 264.

Compared with FIG. 5A, the light shielding layer 55′ of the capacitive touch panel 50′ as shown in 5B has additional areas covering the plurality of metal leads 263 around the capacitive touch panel 50′. The issue of reflecting light from the conductive bridging wires 264 and the metal leads 263 is resolved or reduced. That is, there are no bright dots or bright lines occurring in the sensing area 262.

The above descriptions of the present invention are intended to be illustrative only. Numerous alternative methods may be devised by persons skilled in the art without departing from the scope of the following claims.

What is claimed is:

1. A capacitive touch panel, comprising:
a transparent substrate;
a capacitive sensing circuit device disposed above a first surface of the transparent substrate, comprising a sensing region and a plurality of metal leads around the sensing region, wherein the sensing region comprises a plurality of bridging wires; and
a light shielding layer vertically overlapping the plurality of conductive bridging wires.

2. The capacitive touch panel of claim 1, wherein the light shielding layer is directly disposed on a surface of the substrate and the capacitive sensing circuit device is directly disposed on the light shielding layer.

3. The capacitive touch panel of claim 1, wherein the light shielding layer is directly disposed on a second surface of the substrate and the second surface is opposite the first surface.

4. The capacitive touch panel of claim 1, wherein the capacitive sensing circuit device further comprises a transparent conductive layer, and the plurality of conductive bridging wires and the plurality of metal leads are disposed on the transparent conductive layer.

5. The capacitive touch panel of claim 1, wherein the light shielding layer is directly disposed on the plurality of conductive bridging wires.

6. The capacitive touch panel of claim 4, wherein the light shielding layer is sandwiched between the transparent conductive layer and the plurality of conductive bridging wires.

7. The capacitive touch panel of claim 4, further comprising a protection layer covering the transparent conductive layer, the plurality of conductive bridging wires and the plurality of metal leads.

8. The capacitive touch panel of claim 7, wherein the light shielding layer is sandwiched between the plurality of conductive bridging wires and the protection layer.

9. The capacitive touch panel of claim 1, wherein the light shielding layer further includes areas vertically overlapping the plurality of metal leads.

10. The capacitive touch panel of claim 1, wherein the materials of the conductive bridging wires are silver (Ag), silver alloy, chromium (Cr), a composite metal layer of Mo/Al/Mo, or alloy of each of the aforesaid materials.

11. The capacitive touch panel of claim 4, wherein the material of the transparent conductive layer is conductive oxide.

12. The capacitive touch panel of claim 1, wherein the material of the transparent substrate is glass or a transparent polymer plate.

13. The capacitive touch pane of claim 1, further comprising an insulating layer between the plurality of conductive bridging wires and the transparent conductive layer.
